(19) United States
(12) Patent Application Publication
(10) Pub. No.: US 2025/0280848 A1
(43) Pub. Date: Sep. 11, 2025

(54) PLANT BASED PROTEIN COMPOSITIONS FOR FOOD APPLICATIONS

(71) Applicant: TECHNION RESEARCH & DEVELOPMENT FOUNDATION LIMITED, Haifa (IL)

(72) Inventors: Maya DAVIDOVICH-PINHAS, Haifa (IL); Jovana GLUSAC, Haifa (IL); Ayelet FISHMAN, Haifa (IL)

(21) Appl. No.: 18/858,793

(22) PCT Filed: Apr. 25, 2023
(86) PCT No.: PCT/IL2023/050424

§ 371 Date: Oct. 22, 2024

Related U.S. Application Data
(60) Provisional application No. 63/334,853, filed on Apr. 26, 2022.

(51) Int. Cl. A23D 7/005; A23J 3/14

(52) U.S. Cl. CPC A23D 7/0056; A23D 7/0053; A23J 3/14

(57) ABSTRACT

Bigels and food products comprising an oleogel mixed with a hydrogel, wherein the hydrogel comprises a biopolymer and wherein a concentration of the biopolymer within the hydrogel is between 1% and 40% weight per weight (w/w) are disclosed. Methods of manufacturing such bigels and food products are further disclosed.

### CROSS-REFERENCE TO RELATED APPLICATIONS

This application claims the benefit of priority to U.S. Provisional Application No. 63/334,853, titled “PLANT BASED PROTEIN COMPOSITIONS FOR FOOD APPLICATIONS”, filed on Apr. 26, 2022. The content of the above document is incorporated by reference in its entirety as if fully set forth herein.

### FIELD OF THE INVENTION

The present invention is directed to plant-based protein compositions and methods of manufacturing and using the same such as in preparation of food products.

### BACKGROUND OF THE INVENTION

The food industry is actively seeking new food formulations that can replace and/or mimic animal-based products such as cheese, meat, and eggs due to their clear environmental and sustainability issues. This trend is combined with the desire to improve the nutritional values of food products with the objective of enhancing the population's health and wellbeing. These attempts have led to increased interest in food architecture design and development aiming to mimic the natural product.

Fat replacers have been developed over the last years aiming to reduce saturated fat using, among others, oleogel formulations. There is still a great need for the development of solutions to reduce the total fat content while improving nutritional values and offering additional functionalities of the fat-replacer gel.

### SUMMARY OF THE INVENTION

In one aspect of the invention, there is provided a bigel, comprising an oleogel mixed with a hydrogel, wherein: the hydrogel comprises water and a biopolymer and wherein a concentration of the biopolymer within the hydrogel is between 1% and 40% weight per weight (w/w); the oleogel comprises a vegetable oil and an oil structuring agent, and wherein a concentration of the oil structuring agent within the oleogel is between 0.5% and 30% (w/w); the biopolymer comprises a plant protein and/or a polysaccharide including any salt thereof; and wherein the bigel is characterized by a water content between 10% and 90% (w/w).

In one embodiment, the bigel is substantially devoid of phase separation at a temperature below 100° C. In one embodiment, a concentration of the oleogel within the bigel is between 10% and 80% (w/w).

In one embodiment, the oleogel is characterized by a viscosity at room temperature (RT) between 10 cP and 500000000 cP.

In one embodiment, the plant protein is at least partially cross-linked.

In one embodiment, the plant protein is in the form of self-assembled matrix, and wherein the oleogel is in a form of particles embedded within the matrix.

In one embodiment, the particles are characterized by a particle size between 1 μm and 200 μm.

In one embodiment, the bigel comprises between 5% (w/w) and 80% (w/w) of the plant protein.

In one embodiment, the bigel comprises between 10% (w/w) and 80% (w/w) of the vegetable oil.

In one embodiment, the plant protein is selected from chickpea protein, potato protein, garbanzo protein, fava beans protein, yellow pea protein, rice protein, rye, golden lentil, chana dal, soybean, sorghum, sprouted green lentil, du pung style lentil, white lima bean, hemp, corn, rapeseed, canola including any fraction or any combination thereof.

In one embodiment, the oil structuring agent is selected from the group comprising natural waxes, glycerol monostearate, stearic acid, sorbitan monostearate, phytosterol, or any combination thereof.

In one embodiment, vegetable oil is selected from the group comprising soybean oil, olive oil, rice oil, hemp seed oil, safflower oil, canola oil, sunflower oil, or any combination thereof.

In one embodiment, the polysaccharide is selected from the group comprising alginate, chitosan, hyaluronic acid, pectin, a starch, a gum, agarose, gellan, locust bean gum, Guar gum, xanthan gum, carrageenan, or any combination thereof.

In one embodiment, crosslinked is via a covalent or physical cross-link.

In one embodiment, covalent cross-link is via a cross-linking enzyme, or via a cross-linking agent.

In another aspect, there is provided a food product comprising the bigel of the invention.

In one embodiment, the food product is shapeable, spreadable or both.

In one embodiment, the food product is characterized by a hardness between 1 N and 10000 N.

In one embodiment, the food product characterized as being suitable for use as an equivalent product to meat, eggs, fat substitute, dairy products, meat substitute products, plant-based products, or any combination thereof.

In another aspect, there is a process for manufacturing a bigel comprising an oleogel mixed with a hydrogel, wherein the hydrogel comprises water and a biopolymer and wherein a concentration of the biopolymer within said hydrogel is between 1% and 40% weight per weight (w/w); said oleogel comprises a vegetable oil and an oil structuring agent, and wherein a concentration of the oil structuring agent within the oleogel is between 0.5% and 30% (w/w); the biopolymer comprises a plant protein; and wherein the bigel is substantially devoid of phase separation and is characterized by a water content between 10% and 90% (w/w), the process comprising:
mixing a first solution comprising between 1% and 60% (w/w) of a plant protein with a second solution comprising an oil structuring agent, thereby obtaining a mixture; and
homogenizing the mixture, thereby manufacturing the bigel.

In one embodiment, the first solution comprises an aqueous solution.

In one embodiment, the first solution comprises a vegetable oil.

In one embodiment, a concentration of the oil structuring agent within the second solution is between 0.5% (w/w) and 30% (w/w).

In one embodiment, homogenizing comprises a speed between 5000 rpm and 25000 rpm.

In one embodiment, the process further comprising a step of adding a surfactant to the mixture, optionally wherein the surfactant is selected from lecithin, glycerol, polysorbates (Tween 20,40,60,80), sorbitan esters (Span 20,60,65), sodium stearoyl lactylate, or a combination thereof.

In one embodiment, homogenizing is performed for a time period ranging between 1 second and 30 minutes.

In one embodiment, homogenizing is performed at a temperature between 25° C. and 100° C.

In one embodiment, the process further comprising a step preceding step b., of mixing a third solution comprising a plant protein with the first solution and second solution.

In one embodiment, the third solution further comprises a cross-linking enzyme.

In one embodiment, the enzyme is transglutaminase.

In one embodiment, homogenizing comprises cooling the mixture to a temperature between −20° C. and 30° C.

In one embodiment, the bigel is the bigel of the invention.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 presents a schematic illustration of the bigel preparation procedure;

FIGS. 2A-2B present a bar graph of texture profile analysis obtained for bigel (white) and cooked bigel (doted/gray) (FIG. 2A) and a picture of bigel visual appearance (FIG. 2B);

FIGS. 3A-3B present differential scanning calorimetry (DSC) (FIG. 3A) and thermogravimetric analysis (TGA) (FIG. 3B) thermograms obtained for the bigel system;

FIGS. 4A-4B are cryo-scanning electron microscopy (Cryo-SEM) images of the bigel system;

FIGS. 5A-5B present texture profile analysis (TPA) (FIG. 5A) and visual appearance (FIG. 5B) of bigel (white bars) and beef fat (gray bar) raw (full color) and cooked (dotted pattern);

FIG. 6 presents photographs of bigel formulations with different water:oil ratios (90:10, 80:20, 70:30, 50:50), GMS concentrations (10, 20 and 30% wt.) and CP concentration (5, 10 and 15% wt.);

FIG. 7 presents photographs of non-crosslinked control and TG-crosslinked raw and cooked bigels before and after second compression during texture analysis;

FIG. 8A-8B presents textural parameters obtained from the TPA analysis for raw and cooked control bigel (grey) and bigel+TG (white): Hardness (A) and adhesiveness (B).

### DETAILED DESCRIPTION OF THE INVENTION

According to some embodiments, the present invention provides a bigel, comprising an oleogel mixed with a hydrogel, wherein the hydrogel comprises water and a biopolymer and wherein a concentration of the biopolymer within the hydrogel is between 1% and 40% weight per weight (w/w). In some embodiments the biopolymer comprises a protein. In some embodiments the protein is derived from a natural composition. In some embodiments the protein is derived from a plant. In some embodiments the protein is a plant isolate or a plant extract. In some embodiments the protein is a plant protein (of synthetic or natural origin). In some embodiments the protein is chemically or biologically modified (e.g. including subjecting the protein to any chemical and/or biological processing such as acetylation, deacetylation, alkylation, glycosylation, deglycosylation, phosphorylation, dephosphorylation, hydrolysis, etc.). In some embodiments the protein (e.g. a natural protein) includes non-natural or non-canonic amino acids, and/or chemical modification of the protein backbone. In some embodiments the biopolymer comprises a protein (e.g. plant protein) including any salt thereof, a polysaccharide including any salt thereof, or both. In some embodiments the biopolymer comprises a protein. In some embodiments the polysaccharide is derived from a natural composition. In some embodiments the polysaccharide is derived from a plant.

As used herein, the term “plant protein” including any grammatical form thereof encompasses any protein that is naturally present or is derived from a plant or a plant part, including a root, a stem, a leave, a flower, a fruit, and a seed. In some embodiments, the plant protein has an amino acid sequence identical to the amino acid sequence of a natural plant protein. One skilled in the art will appreciate that the protein (e.g. plant protein) may further comprise modifications, such as glycosylation, phosphorylation, methylation, etc.; and/or the plant protein may be covalently conjugated or physically complexed to a polysaccharide. In some embodiments, the plant protein is in a form of plant protein enriched composition, i.e., any composition or extract enriched by plant proteins.

In some embodiments the polysaccharide is a plant isolate or a plant extract. In some embodiments the polysaccharide is a plant polysaccharide (of synthetic or natural origin). In some embodiments the polysaccharide is chemically or biologically modified (e.g. including subjecting the polysaccharide to any chemical and/or biological processing such as acylation, diacylation, acetylation, deacetylation, alkylation, glycosylation, deglycosylation, phosphorylation, dephosphorylation, hydrolysis, etc.). In some embodiments the biopolymer comprises a protein-polysaccharide conjugate.

In some embodiments, the oleogel comprises a vegetable oil and an oil structuring agent. In some embodiments, the bigel is substantially devoid of phase separation.

According to some embodiments, the present invention provides a composition comprising a bigel, comprising an oleogel mixed with a hydrogel, wherein the hydrogel comprises water and a biopolymer and wherein a concentration of the biopolymer within the hydrogel is between 1% and 40% weight per weight (w/w). In some embodiments the biopolymer comprises a protein (e.g. plant protein) including any salt thereof, a polysaccharide including any salt thereof, or both; and wherein the composition is substantially devoid of phase separation. In some embodiments, the oleogel comprises a vegetable oil and an oil structuring agent. In some embodiments, the composition is in the form of a soft matter. In some embodiments, the composition is in the form of a gel. In some embodiments, the composition is characterized by a water content between 10% (w/w) and 90% (w/w). In some embodiments, the composition is in the form of an emulsion. In some embodiments, the composition is substantially stable.

In some embodiments, the composition is an edible composition. In some embodiments, the composition is a food product. In some embodiments, the composition of the invention consists essentially of food-grade constituents. As used herein, the term “food grade” refers to a product consisting of food-grade ingredients approved for human consumption by a corresponding regulatory authority (i.e., GRAS). The concentration of each of the constituents within the food grade doesn't exceed a toxicity limit for the specific constituent as determined by the corresponding regulatory authority.

According to some embodiments, the present invention provides a food product comprising a bigel, wherein the bigel comprises an oleogel mixed with a hydrogel, wherein: the hydrogel comprises water and a biopolymer; and wherein a concentration of the biopolymer within the hydrogel is between 1% and 30% weight per weight (w/w); the oleogel comprises a vegetable oil and an oil structuring agent, and wherein a concentration of the oil structuring agent within the oleogel is between 0.5% and 30% (w/w); the biopolymer comprises a protein (e.g. plant protein) including any salt thereof, a polysaccharide including any salt thereof, or both; and the bigel is substantially devoid of phase separation and is characterized by a water content between 10% and 90% (w/w). In some embodiments, the food product is in the form of a stable emulsion.

As used herein, the term “edible composition” refers to a composition suitable for consumption, typically via the oral cavity (although consumption may occur via non-oral means such as inhalation). Edible compositions may be present in any form including, but not limited to, liquids, solids, semi-solids, tablets, lozenges, powders, gels, gums, pastes, flurries, syrups, aerosols and sprays. As used herein, edible compositions include food products, pharmaceutical compositions, and consumer products. The term “edible compositions” also refers to, for example, dietary and nutritional supplements.

In some embodiments, the composition and/or food product is flowable. In some embodiments, the composition and/or food product is in a form of a gel. In some embodiments, the composition and/or food product is in a form of a semi-solid. In some embodiments, the composition and/or food product is in a form of a semi-liquid. In some embodiments, the composition and/or food product is in a form of a shapeable solid. In some embodiments, the composition and/or food product is spreadable. In some embodiments, the composition is a viscous composition or a viscoelastic composition. In some embodiments, the composition and/or food product is in the form of a bigel. As used herein, the term “semi-liquid” refers to a non-Newtonian fluid, that its viscosity depends on the shear rate, wherein increasing shear rate decrease its viscosity.

As used herein, the term “bigel” refers to the combination of two immiscible phases such as a hydrogel and oleogel resulting in a stable composition (or composite), being substantially devoid of phase separation and/or aggregation. Hybrid gels are biphasic systems comprising water-based gels (hydrogels) and oil-based gels (oleogels). The presence of hydrogel and oleogel within a composition (such as the bigel of the invention) can be determined by solid state NMR and/or Raman spectroscopy.

In some embodiments, the bigel of the invention comprises a hydrogel and an oleogel mixed together, resulting in a substantially stable and uniform composition being devoid of phase separation at a temperature of up to 100° C., up to 90° C., up to 80° C., up to 60° C., including any range between. In some embodiments, the bigel of the invention comprises a hydrogel and an oleogel homogenously distributed therewithin, such as in a form of a biphasic mixture, or in a form of a matrix encapsulating oleogel or hydrogel particles or droplets (e.g., the oleogel particles distributed with a biopolymer matrix; or alternatively hydrogel particles distributed within the oleogel matrix). In some embodiments, the bigel of the invention is in a form of a bi-continuous phase, or in a form of a dispersion, such as a water in oil (e.g., hydrogel particles distributed within the oleogel matrix), or oil in water dispersion (e.g., oleogel particles distributed with a biopolymer matrix).

In some embodiments, the presence of oleogel particles within the matrix (or vice versa) can be determined by solid state NMR and Raman spectroscopy.

As used herein, the term “matrix” refers to a bulk material in a form of one or more porous layers of intertwined or tortious biopolymer molecules (in the case of the biopolymer matrix) that are randomly distributed therewithin. Biopolymer matrix further includes water and optionally oleogel (e.g. oleogel droplets) incorporated between the biopolymer molecules and/or interposed between the layers. In some embodiments, the biopolymer molecules and the water are held or bound by physical interactions. In some embodiments, the matrix comprises randomly oriented polymeric chains. In some embodiments, the matrix is devoid of ordered structure (i.e. biopolymer molecules having a uniform directionality or orientation). To those skilled in the art methods for determining an ordered structure are well known in the art, for example XRD or Raman.

In some embodiments, each polymeric chain within the matrix is in contact with at least one additional polymeric chain. In some embodiments, the intertwined polymeric chains are randomly distributed within the matrix, to obtain a three-dimensional mesh structure comprising a void space (pores) between the chains. In some embodiments, the matrix is a continuous bulk. In some embodiments, the matrix is devoid of a solid particulate matter (e.g., spherical solid particles, microparticles, core-shell particles; not to be confused with the continuous matrix disclosed herein).

The present invention is based, in part, on the finding that compositions and food products according to the present invention, exhibit an improved stability, high protein content as well as improved nutritional values (e.g., high protein content and low saturated fat), compared to formulations comprising one of the materials, or the same materials but having different volume or weight ratios thereof.

The present invention is based, in part, on the finding that the stability of the bigel structure according to the present invention, is based on a combination of oleogel particles (or droplets) stabilized by the biopolymer network, or vice versa (i.e., oleogel matrix stabilizing hydrogel particles or droplets). A skilled artisan will appreciate that the exact structure of the bigel depends on the weight ratio between two phases (oleogel and hydrogel) within the bigel, thus resulting in a variety of structures selected from bi-continuous phase, oil in water or water in oil dispersion, etc.

The present invention is based, in part, on the finding that bigel, compositions and food products according to the present invention, comprising inter alia at least two different plant protein species are characterized by an increased protein content and versatile amino acid profile, as compared to bigel based on a single plant protein specie.

In some embodiments, the term “stable” refers to the ability of the bigel and/or food product to substantially maintain its structural, physical, and/or chemical properties. In some embodiments, the term “stable” including any grammatical form thereof refers to a bigel and/or food product devoid of phase separation, precipitation, chemical decomposition of: the biopolymer, the vegetable oil, of the oil structuring agent and/or any combination thereof, under suitable storage conditions as described herein. In some embodiments, a stable bigel substantially retains the initial oil and/or protein content, wherein substantially is between 60 and 99.9%, between 70 and 80%, between 70 and 90%, between 80 and 90%, between 90 and 95%, between 95 and 99.9%, including any range between.

As used herein, the term “improved stability” refers to a food product having an increased shelf life, or maintaining its structural property, physical property and/or chemical property, as compared to formulations comprising one of the materials, or the same materials but having different volume or weight ratios thereof. In some embodiments, improved stability refers to a bigel and/or food product devoid of phase separation, precipitation, decomposition of a plant protein, decomposition of a vegetable oil, decomposition of an oil structuring agent and any combination thereof, and any combination thereof, compared to formulations comprising one of the materials, or the same materials but having different volume or weight ratios thereof. The terms “stability” and “shelf life’ are used herein interchangeably.

In some embodiments, the composition or the food product is stable for a time period of at least 10 days, at least 30 days, at least 60 days, at least 90 days, at least 120 days, at least 160 days, at least 190 days, or at least 1 year, including any value therebetween. In some embodiments, the food product is characterized by a stability (or shelf life) of at least 10 days, at least 30 days, at least 60 days, at least 90 days, at least 120 days, at least 160 days, at least 190 days, or at least 1 year, including any value therebetween. Each possibility represents a separate embodiment of the invention.

### Bigel

According to some embodiments, the present invention provides a bigel, comprising an oleogel mixed with a hydrogel, wherein: the hydrogel comprises water and a biopolymer; wherein a concentration of the biopolymer within the hydrogel is between 1% and 30% weight per weight (w/w). In some embodiments the biopolymer comprises a plant protein, or a mixture of a plant protein and a polysaccharide. In some embodiments, the oleogel comprises a vegetable oil and an oil structuring agent. In some embodiments, a concentration of the oil structuring agent within the oleogel is between 0.5% and 30% (w/w). In some embodiments, the bigel is substantially devoid of phase separation.

In some embodiments, the bigel is characterized by a water content between 10% and 90% (w/w). In some embodiments, the bigel is characterized by a water content between 2% (w/w) and 90% (w/w), between 5% (w/w) and 90% (w/w), between 10% (w/w) and 90% (w/w), between 15% (w/w) and 90% (w/w), between 25% (w/w) and 90% (w/w), between 30% (w/w) and 90% (w/w), between 10% (w/w) and 80% (w/w), between 15% (w/w) and 80% (w/w), between 25% (w/w) and 80% (w/w), between 30% (w/w) and 80% (w/w), between 10% (w/w) and 75% (w/w), between 15% (w/w) and 75% (w/w), between 25% (w/w) and 75% (w/w), between 30% (w/w) and 75% (w/w), between 5% (w/w) and 60% (w/w), between 10% (w/w) and 60% (w/w), between 15% (w/w) and 60% (w/w), between 25% (w/w) and 60% (w/w), between 30% (w/w) and 60% (w/w), between 1% (w/w) and 50% (w/w), between 2% (w/w) and 50% (w/w), between 5% (w/w) and 50% (w/w), between 10% (w/w) and 50% (w/w), between 15% (w/w) and 50% (w/w), between 25% (w/w) and 50% (w/w), between 30% (w/w) and 50% (w/w), between 2% (w/w) and 40% (w/w), between 5% (w/w) and 40% (w/w), between 10% (w/w) and 40% (w/w), between 15% (w/w) and 40% (w/w), between 25% (w/w) and 40% (w/w), or between 30% (w/w) and 40% (w/w), including any range therebetween. Each possibility represents a separate embodiment of the present invention.

In some embodiments, the bigel is characterized by a water content between 50% (w/w) and 95% (w/w), between 50% (w/w) and 90% (w/w), between 50% (w/w) and 90% (w/w), between 50% (w/w) and 80% (w/w), between 60% (w/w) and 80% (w/w), between 555% (w/w) and 850% (w/w), between 65% (w/w) and 75% (w/w), between 60% (w/w) and 90% (w/w), between 60% (w/w) and 90% (w/w), between 65% (w/w) and 95% (w/w), including any range therebetween. Each possibility represents a separate embodiment of the present invention.

In some embodiments, the bigel comprises between 1% (w/w) and 40% (w/w), between 5% (w/w) and 40% (w/w), between 10% (w/w) and 40% (w/w), between 15% (w/w) and 40% (w/w), between 20% (w/w) and 40% (w/w), or between 21% (w/w) and 40% (w/w), of the biopolymer, including any range therebetween. Each possibility represents a separate embodiment of the present invention.

In some embodiments, the bigel comprises between 10% (w/w) and 30% (w/w), between 10% (w/w) and 25% (w/w), between 10% (w/w) and 20% (w/w), between 15% (w/w) and 30% (w/w), between 15% (w/w) and 25% (w/w), or between 15% (w/w) and 20% (w/w), of the biopolymer, including any range therebetween. Each possibility represents a separate embodiment of the present invention.

In some embodiment, the biopolymer is a natural product. In some embodiments, the biopolymer is derived from a natural product. As used herein, the term “derived from” encompasses any industrial processing such as purification, isolation, fractionation, fermentation, chemical modification, etc. In some embodiments, the biopolymer is a protein hydrolysate. In some embodiments, the biopolymer is a fermented protein.

In some embodiments, the biopolymer comprises at least 1% (w/w), at least 5% (w/w), at least 6% (w/w), at least 8% (w/w), at least 10% (w/w), at least 15% (w/w), at least 20% (w/w), at least 21% (w/w), at least 22% (w/w), at least 25% (w/w), at least 30% (w/w), at least 35% (w/w), at least 40% (w/w), at least 45% (w/w), or at least 50% (w/w), of a plant protein, including any value therebetween. Each possibility represents a separate embodiment of the present invention.

In some embodiments, the plant protein content of the biopolymer is between 1% (w/w) and 80% (w/w), between 5% (w/w) and 80% (w/w), between 10% (w/w) and 80% (w/w), between 15% (w/w) and 80% (w/w), between 20% (w/w) and 80% (w/w), between 21% (w/w) and 80% (w/w), between 5% (w/w) and 60% (w/w), between 10% (w/w) and 60% (w/w), between 15% (w/w) and 60% (w/w), between 20% (w/w) and 60% (w/w), between 21% (w/w) and 60% (w/w), between 5% (w/w) and 50% (w/w), between 10% (w/w) and 50% (w/w), between 15% (w/w) and 50% (w/w), between 20% (w/w) and 50% (w/w), between 1% (w/w) and 40% (w/w), between 5% (w/w) and 40% (w/w), between 10% (w/w) and 40% (w/w), between 15% (w/w) and 40% (w/w), between 20% (w/w) and 40% (w/w), or between 21% (w/w) and 50% (w/w), including any range therebetween. Each possibility represents a separate embodiment of the present invention. In some embodiments, the plant protein content of the biopolymer is between 1% (w/w) and 40% (w/w), between 5% (w/w) and 40% (w/w), between 10% (w/w) and 40% (w/w), between 15% (w/w) and 40% (w/w), between 20% (w/w) and 40% (w/w), or between 21% (w/w) and 40% (w/w), of the biopolymer, including any range therebetween. Each possibility represents a separate embodiment of the present invention.

In some embodiments, the biopolymer consists essentially of the plant protein, wherein the plant protein has a chemical purity of at least 50%, at least 60%, at least 70%, at least 80%, or at least 90%, including any range or value in between.

In some embodiments, the chemical purity of the biopolymer is of between 50 and 100%, between 50 and 90%, between 60 and 100%, between 70 and 95%, between 80 and 100%, between 70 and 99%, between 70 and 100%, between 80 and 100%, between 90 and 99.99%, including any range in between.

In some embodiments, the impurities present in the biopolymer comprise polysaccharides, lignin, salts, fats, oils, or any plant-derived material.

In some embodiments, the plant protein comprises a vegetable protein. Non-limiting examples of plant protein according to the present invention include protein derived from chickpea, legume, potato, sweet potato, wheat, algae, garbanzo, fava beans, yellow pea, rice, sweet brown rice, rye, cereal, golden lentil, chana dal, soybean, sorghum, sprouted green lentil, du pung style lentil, white lima bean, corn, hemp, canola, rapeseed including any protein isolate and/or protein hydrolysate, or any combination thereof.

In some embodiments, the biopolymer within the bigel is composed of a single plant protein species, or comprises a plurality (e.g., 2, 3, 4, 5) chemically distinct plant protein species. In some embodiments, the bigel comprises two distinct plant proteins. In some embodiments, biopolymer comprises a potato protein and an additional plant protein comprises or is.

In some embodiments, the biopolymer further comprises a polysaccharide. Non-limiting examples of suitable polysaccharides according to the present invention include chitosan, alginate, starch, a gum, pectin, hyaluronic acid, agarose, gellan, locust bean gum, carrageenan, including an alkylated, or an acetylated derivative thereof, and/or or any salt or any combination thereof.

In some embodiments, the plant protein is a hydrogel forming protein.

In some embodiments, the term “hydrogel” refers to a non-Newtonian fluid comprising a supramolecular structures of self-assembled biopolymer molecules (e.g., the plant protein and/or the polysaccharide) and water. In some embodiments, the supramolecular structures are in a form of a three-dimensional network of biopolymer molecules. In some embodiments, the supramolecular structures are physically bound to water molecules. In some embodiments, the biopolymer is homogenously distributed (e.g., dispersed) within the hydrogel, and is substantially devoid of precipitation or clusters. In some embodiments, the biopolymer molecules within the hydrogel of the invention are substantially in a form of distinct molecules, so that the hydrogel is devoid of biopolymer precipitations or curded biopolymer. Hydrogel is characterized by a greater viscosity than water (at a temperature between 20 and 30° C., or about 25° C.), usually of at least 10 cP and is further characterized by a non-Newtonian behavior.

In some embodiments, the plant protein within the bigel is in a form of self-assembled biopolymer molecules. In some embodiments, the plant protein is capable of undergoing self-assembly upon contacting thereof with an aqueous solution/water, thereby forming a three-dimensional protein network. In some embodiments, the three-dimensional protein network comprises at least partially cross-linked protein molecules. In some embodiments, cross-linked is via non-covalent interactions (also referred to herein as physical interactions). In some embodiments, the three-dimensional protein network comprises intertwined protein molecules and water. In some embodiments, the water is at least partially bound to the protein molecules. In some embodiments, the three-dimensional protein network and water molecules bound thereto form a hydrogel. In some embodiments, the plant protein is capable of forming a hydrogel in contact with an aqueous solution or water.

In some embodiments, the plant protein is at least partially cross-linked within the bigel. In some embodiments, crosslinked is via a covalent bond. In some embodiments, crosslinked is via physical interactions (e.g., hydrogen bonding, dipole-dipole interactions, electrostatic interactions, etc.).

As used herein, the term “cross-linking” refers to the formation of a chemical bond between two chemical moieties or groups. In some embodiments, cross-linking comprises inter cross-linking (e.g., wherein the chemical moieties are distinct protein chains). In some embodiments, cross-linking comprises intra cross-linking (e.g., wherein the chemical moieties are within the same protein chain).

In some embodiments, the covalent cross-link is formed via a cross-linking enzyme. In some embodiments, the covalent cross-link is formed via a cross-linking agent. In some embodiments, the cross-linking agent is a food grade cross-linking agent. Exemplary cross-linking agent include but are not limited to: citric acid, tannic acid and EGCG (Epigallocatechin gallate).

In some embodiments, the cross-linking enzyme is selected from, without being limited thereto, tyrosinase, peroxidase, transglutaminase, lipoxygenase, protein sulfide reductase, protein disulfide isomerase, sulfhydryl oxidase, hexose oxidase, lysyl oxidase, amine oxidase, glucose oxidase, hexose oxidase, pentose oxidase, or laccase. In some embodiments, the cross-linking enzyme is transglutaminase. In some embodiments, the cross-linking enzyme described herein may be utilized in a form of an isolated enzyme or a purified enzyme, or in a form of an enzyme preparation selected from, without being limited thereto, a whole cell extract, a cell extract containing the enzyme, etc.

In some embodiments, the cross-linking (e.g. covalent crosslinking) increases the bigel and/or food product stability and hardness. In some embodiments, the hardness of a covalently cross-linked bigel is at least 2, at least 3, at least 4 times, at least 10 times greater than the hardness of a similar non-crosslinked bigel.

In some embodiments, the bigel comprises at least 10% (w/w), at least 21% (w/w), at least 22% (w/w), at least 25% (w/w), at least 30% (w/w), at least 35% (w/w), at least 40% (w/w), at least 45% (w/w), or at least 50% (w/w) of an oleogel comprising a vegetable oil and an oil structuring agent, including any value therebetween. Each possibility represents a separate embodiment of the present invention.

In some embodiments, the bigel comprises between 10% (w/w) and 80% (w/w), between 10% (w/w) and 60% (w/w), between 10% (w/w) and 50% (w/w), between 10% (w/w) and 30% (w/w), between 20% (w/w) and 80% (w/w), between 30% (w/w) and 80% (w/w), between 40% (w/w) and 80% (w/w), or between 10% (w/w) and 40% (w/w) of an oleogel comprising a vegetable oil and an oil structuring agent, including any value therebetween. Each possibility represents a separate embodiment of the present invention.

In some embodiments, the bigel comprises between 10% (w/w) and 50% (w/w), between 10% (w/w) and 40% (w/w), between 10% (w/w) and 30% (w/w), between 10% (w/w) and 20% (w/w), between 20% (w/w) and 50% (w/w), between 20% (w/w) and 40% (w/w), between 15% (w/w) and 45% (w/w), or between 10% (w/w) and 45% (w/w) of an oleogel comprising a vegetable oil and an oil structuring agent, including any value therebetween. Each possibility represents a separate embodiment of the present invention.

In some embodiments, the bigel comprises at least 0.5% (w/w), at least 0.9% (w/w), at least 1% (w/w), at least 5% (w/w), at least 10% (w/w), at least 15% (w/w), at least 20% (w/w), or at least 25% (w/w) of an oil structuring agent, including any value therebetween. Each possibility represents a separate embodiment of the present invention.

In some embodiments, the bigel comprises between 0.1% (w/w) and 40% (w/w), between 0.5% (w/w) and 30% (w/w), between 0.7% (w/w) and 30% (w/w), between 0.9% (w/w) and 30% (w/w), between 1% (w/w) and 30% (w/w), between 5% (w/w) and 30% (w/w), between 10% (w/w) and 30% (w/w), between 15% (w/w) and 30% (w/w), between 20% (w/w) and 30% (w/w), between 0.1% (w/w) and 25% (w/w), between 0.5% (w/w) and 25% (w/w), between 0.7% (w/w) and 25% (w/w), between 0.9% (w/w) and 25% (w/w), between 1% (w/w) and 25% (w/w), between 5% (w/w) and 25% (w/w), between 10% (w/w) and 25% (w/w), or between 15% (w/w) and 25% (w/w), of the oil structuring agent, including any range therebetween. In some embodiments, the bigel comprises between 5% (w/w) and 35% (w/w), between 5% (w/w) and 15% (w/w), between 5% (w/w) and 25% (w/w), between 5% (w/w) and 30% (w/w), between 20% (w/w) and 35% (w/w), between 25% (w/w) and 35% (w/w), between 10% (w/w) and 30% (w/w), between 15% (w/w) and 35% (w/w), including any range therebetween of the oil structuring agent. Each possibility represents a separate embodiment of the present invention.

In some embodiments, the oleogel comprises at least 0.5% (w/w), at least 0.9% (w/w), at least 1% (w/w), at least 5% (w/w), at least 10% (w/w), at least 15% (w/w), at least 20% (w/w), or at least 25% (w/w) of an oil structuring agent, including any value therebetween. Each possibility represents a separate embodiment of the present invention.

In some embodiments, the oleogel comprises between 0.1% (w/w) and 40% (w/w), between 0.5% (w/w) and 30% (w/w), between 0.7% (w/w) and 30% (w/w), between 0.9% (w/w) and 30% (w/w), between 1% (w/w) and 30% (w/w), between 5% (w/w) and 30% (w/w), between 10% (w/w) and 30% (w/w), between 15% (w/w) and 30% (w/w), between 20% (w/w) and 30% (w/w), between 0.1% (w/w) and 25% (w/w), between 0.5% (w/w) and 25% (w/w), between 0.7% (w/w) and 25% (w/w), between 0.9% (w/w) and 25% (w/w), between 1% (w/w) and 25% (w/w), between 5% (w/w) and 25% (w/w), between 10% (w/w) and 25% (w/w), or between 15% (w/w) and 25% (w/w), of the oil structuring agent, including any range therebetween. Each possibility represents a separate embodiment of the present invention.

As used herein, the term “oil structuring agent” refers to a gelator used to structure an oil, to obtain an oleogel characterized by a significantly greater viscosity, as compared to pristine (non-structured) oil. Structured oils are referred to as oleogels, in which the continuous lipid phase is an edible oil, and the structuring agent undergoes self-assembly, to induce noncovalent cross-linking of the lipids and/or fatty acids, thus forming supramolecular structure. In some embodiments, the supramolecular structure forms a three-dimensional network of structuring agent molecules, wherein the oil molecules are bound by physical interactions (e.g., hydrogen bonding, dipole-dipole interactions, electrostatic interactions, etc.) or entrapped therewithin. In some embodiments, the oleogel is characterized by a viscosity at room temperature (RT) between 10 cP and 100,000 cP, including any range between.

In some embodiments, the oil structuring agent is dispersible within the oil. In some embodiments, the oil is an edible oil. In some embodiments the oil is edible. In some embodiments the oil comprises unsaturated fatty acids and/or esters thereof. In some embodiments, the oil structuring agent is capable of undergoing self-assembly upon contact thereof with oil. Oil structuring agents include low and high-molecular weight oil gelators (LMOGs and HMOGs). LMOGs include e.g., glycerol mono-stearate (GMS) and waxes, while HMOGs include polymers and proteins. As used herein, the term “low molecular weight oil gelator (LMOG)” refers to a class of molecules that are able to form supramolecular structures and having a molecular weight of less than 1000 Da, less than 800 Da, less than 600 Da, less than 500 Da, including any range between.

Non-limiting examples of LMOG include fatty acid alcohols, fatty acid esters, L-glutamic acid derivatives, fatty acid amides, waxes, wax esters, ceramides, lecithin, oligopeptides, and combinations thereof.

In some embodiments, the LMOG is selected from the group comprising glycerol monostearate, stearic acid, sorbitan monostearate, phytosterol, berry wax, bee-wax, sunflower wax, candelilla wax, rice bran wax, carnauba wax, or any combination thereof.

In some embodiments, the oil structuring agent is selected from the group comprising glycerol monostearate, stearic acid, sorbitan monostearate, phytosterol, berry wax, sunflower wax, candelilla wax, rice bran wax, carnauba wax, or any combination thereof.

In some embodiments, the bigel comprises between 10% (w/w) and 80% (w/w), between 20% (w/w) and 80% (w/w), between 23% (w/w) and 80% (w/w), between 25% (w/w) and 80% (w/w), between 30% (w/w) and 80% (w/w), between 35% (w/w) and 80% (w/w), between 40% (w/w) and 80% (w/w), between 20% (w/w) and 50% (w/w), between 21% (w/w) and 50% (w/w), between 23% (w/w) and 50% (w/w), between 25% (w/w) and 50% (w/w), between 30% (w/w) and 50% (w/w), between 35% (w/w) and 50% (w/w), or between 40% (w/w) and 50% (w/w) of the vegetable oil, including any range therebetween. Each possibility represents a separate embodiment of the present invention.

In some embodiments, the bigel comprises between 10% (w/w) and 50% (w/w), between 20% (w/w) and 50% (w/w), between 10% (w/w) and 40% (w/w), between 20% (w/w) and 40% (w/w), between 15% (w/w) and 45% (w/w), between 15% (w/w) and 35% (w/w), between 25% (w/w) and 35% (w/w), between 25% (w/w) and 50% (w/w), between 21% (w/w) and 50% (w/w), between 23% (w/w) and 50% (w/w), between 25% (w/w) and 50% (w/w), between 30% (w/w) and 50% (w/w), between 35% (w/w) and 50% (w/w), or between 40% (w/w) and 50% (w/w) of the vegetable oil, including any range therebetween. Each possibility represents a separate embodiment of the present invention.

Suitable vegetable oils according to the present invention include natural vegetable oil, synthetic vegetable oil, genetically modified vegetable oil, and any combination thereof. In some embodiments, the vegetable oil is a food-grade vegetable oil. In some embodiments, the vegetable oil is rich in unsaturated fat. In some embodiments, the vegetable oil comprises an unsaturated fatty acid and/or a glycerol ester thereof. In some embodiments, the vegetable oil is made for example, from nuts and oily seeds or from other parts of a plant, like flowering tops, flowers, leaves, fruit, roots and rhizomes.

Non-limiting examples of vegetable oils according to the present invention include hemp seed oil, safflower oil, canola oil, linseed oil, macadamia oil, walnut oil, argan oil, olive oil, palm oil, bi-fractionated palm oil, refined palm oil, castor oil, rice oil, peanut oil, sunflower seed oil, corn oil, sesame seed oil, oil of soya beans, grapeseed oil, avocado oil and any combination thereof.

In some embodiments, the vegetable oil is selected from the group comprising soybean oil, olive oil, rice oil, hemp seed oil, safflower oil, canola oil, sunflower oil, or any combination thereof. In some embodiments, the oleogel is characterized by a viscosity at room temperature between 10 cP and 500000000 cP, between 10 cP and 50000 cP, between 1000 cP and 500000000 cP, between 5000 cP and 500000000 cP, between 50000 cP and 500000000 cP including any range therebetween. As used herein the term “room temperature” refers to a temperature between 21° C. and 27° C., or about 25° C.

In some embodiments, the bigel is in a form of a solid. In some embodiments, the bigel is in a form of a semi-solid. In some embodiments, the bigel is in a form of a semi-liquid. In some embodiments, the bigel is in a form of a squeezable liquid. In some embodiments, the bigel is in a form of a shapable solid and/spreadable. In some embodiments, the bigel is in a form of a shapable solid. In some embodiments, the bigel is in a form of a spreadable solid.

In some embodiments, a shapeable bigel is characterized by a viscosity of between 1,000,000 and 5,000,000, between 1,000,000 and 4,000,000, between 1,000,000 and 3,000,000, between 1,000,000 and 2,000,000, between 1,000,000 and 1,500,000, including any range in between, at a temperature of between 21° C. and 27° C. or about 25° C. Each possibility represents a separate embodiment.

In some embodiments, a spreadable bigel is characterized by a viscosity of between 100,000 and 1,000,000, between 100,000 and 750,000, between 100,000 and 500,000, between 100,000 and 250,000, between 100,000 and 150,000, between 250,000 and 750,000, including any range in between, at a temperature of between 21° C. and 27° C. or about 25° C. Each possibility represents a separate embodiment.

In some embodiments, a semi-liquid bigel and/or a semi-solid bigel is characterized by a viscosity of between 10 and 10,000, between 10 and 7,500, between 10 and 100, between 10 and 500, between 150 and 350, between 10 and 5,000, between 10 and 2,500, between 10 and 1,000, including any range in between, at a temperature of between 21° C. and 27° C. or about 25° C. Each possibility represents a separate embodiment.

In some embodiments, a squeezable liquid bigel is characterized by a viscosity of between 10,000 and 100,000, between 10,000 and 80,000, between 10,000 and 60,000, between 10,000 and 30,000, between 30,000 and 70,000, between 10,000 and 50,000, between 15,000 and 75,000, including any range in between, at a temperature of between 21° C. and 27° C. or about 25° C. Each possibility represents a separate embodiment.

In some embodiments, the bigel is in a form of a dispersion. In some embodiments the dispersion comprises a plurality of particles or droplets (e.g., liquid or flowable particles or gel particles) dispersed within a matrix (e.g., oleogel matrix, biopolymer matrix). In some embodiments, the plurality of particles is embedded within the matrix. In some embodiments, the plurality of particles comprises the oleogel or the hydrogel. In some embodiments, the hydrogel comprises the biopolymer in a form of a self-assembled matrix. In some embodiments, the oleogel is in a form of particles or droplets embedded within the biopolymer matrix. In some embodiments, the matrix is a major phase.

In some embodiments, the oleogel is in a form of a matrix (major phase) and the hydrogel is in a form of particles or droplets embedded within the biopolymer matrix.

In some embodiments, the bigel is in a form of a continuous bulk material or a continuous matrix. In some embodiments, the continuous bulk material is devoid of core-shell particles (such as particles having an oleogel core and a protein shell, or vice versa). In some embodiments, the bigel is a bulk material, devoid of distinct solid core-shell nano-particles or micro-particles. In some embodiments, the bigel devoid of a solid particulate material.

In some embodiments, the plurality of particles or droplets (i.e., hydrogel particles or oleogel particles) is characterized by an average particle size of between 1 μm and 500 μm, between 10 μm and 500 μm, between 15 μm and 500 μm, between 30 μm and 500 μm, between 50 μm and 500 μm, between 100 μm and 200 μm, between 100 μm and 300 μm, between 100 μm and 400 μm, between 100 μm and 500 μm, between 100 μm and 500 μm, between 1 μm and 150 μm, between 10 μm and 150 μm, between 15 μm and 150 μm, between 30 μm and 150 μm, between 50 μm and 150 μm, or between 100 μm and 150 μm, including any range therebetween. Each possibility represents a separate embodiment of the present invention.

As used herein, the term “average particle size” refers to an average dimeter of the particle, determined by a method selected from SEM, AFM, and DLS.

In some embodiments, the bigel comprises droplets characterized by an average size between 1 μm and 200 μm. In some embodiments, the droplets comprise water droplets, oil droplets, or both.

According to some embodiments, the present invention provides a composition comprising the bigel described herein. In some embodiments, the composition is in the form of a soft matter.

As used herein, the term “soft matter” refers to a composition which properties are between the liquid phase and the solid state. Soft matter can be easily deformed by thermal fluctuations and external forces. In some embodiments, the soft matter is characterized by a storage modulus higher than the loss modulus.

In some embodiments, soft matter refers to colloidal dispersions. In some embodiments, the soft matter is substantially stable, as described hereinabove.

### Food Product

According to some embodiments, the present invention provides a food product comprising the bigel described herein. In some embodiments, the present invention provides a food product consisting essentially of the bigel described herein.

As used herein, the term “food product” refers to a material, a substance, or an additive, which can be used as food, or which can be added to food. Typically, the food product is any composition that an animal, preferably a mammal such as a human, may consume as part of its diet. In some embodiments, food product refers to a food supplement.

In some embodiments, the food product is shapeable, spreadable or both.

In some embodiments, the food product of the invention is characterized by a predetermined shape. In some embodiments, the predetermined shape is any of a sphere, a hemisphere, a hollow sphere, a cylinder, a hollow cylinder, a hollow hemisphere, a cone, a pyramid, a horseshoe, or any other 3-D shape. In some embodiments, the predetermined shape is an irregular shape. The food product of the invention can be generally shaped as a sphere, incomplete-sphere, a rod, a cylinder, a ribbon, a sponge, and any other shape, or can be in a form of a cluster of any of these shapes or can comprise a mixture of one or more shapes.

In some embodiments, non-limiting examples of shaped food products are sphere (meat ball), disc-like shape (e.g., hamburger), chunk (cube) (e.g., lard, yogurt), cylinder (sausage), slices, strips, etc.

In some embodiments, the food product substantially maintains its shape under heating at a temperature up to 200° C., and between −20 and 200° C., between −20 and 0° C., between −20 and 10° C., between 0 and 25° C., between 2° and 50° C., between 25 and 200° C., between 25 and 100° C., between 5° and 150° C., between 100 and 200° C., including any range in between. In some embodiments, the food product is shapeable, spreadable or both; and wherein the food product maintains its shape under heating at a temperature up to 200° C.

In some embodiments, the food product is characterized by at least one of: a hardness between 0.1 and 15 N, a cohesiveness between 0.1 and 1 N, a gumminess between 0.1 and 5 N, and adhesiveness between 1 and 15 Nmm, determined by Texture Profile Analyzer.

In some embodiments, the food product is characterized by a hardness between 0.1 N and 10000 N, between 0.1 N and 100 N, between 1 N and 10000 N, between 1 N and 1000 N, between 1 N and 100 N, between 10 N and 10000 N, between 100 N and 10000 N, including any range between.

In some embodiments, the food product is characterized by a hardness between 0.1 N and 15 N, between 0.1 N and 10 N, between 0.1 N and 5 N, between 1 N and 15 N, between 1 N and 10 N, between 1 and 5 N, including any range between, determined by Texture Profile Analyzer.

In some embodiments, the food product is characterized by a gumminess between 0.1 N and 5 N, between 0.1 N and 1 N, between 0.1 N and 2.5 N, between 1 N and 1.5 N, between 0.1 N and 1 N, between 0.1 N and 4 N, including any range between, determined by Texture Profile Analyzer.

In some embodiments, the food product is characterized by a cohesiveness between 0.1 N and 1 N, between 0.1 N and 0.8 N, between 0.1 N and 0.6 N, between 0.1 N and 0.4 N, between 0.15 N and 0.8 N, including any range between, determined by Texture Profile Analyzer. Each possibility represents a separate embodiment of the present invention.

In some embodiments, the food product is characterized by an adhesiveness between 1 and 15 Nmm, between 1 and 10 Nmm, between 2 and 5 Nmm, between 1 and 5 Nmm, between 3 and 10 Nmm, including any range between, determined by Texture Profile Analyzer.

In some embodiments, the food product is in a denatured state (is also referred to herein as “denatured food product”). The terms “denatured food product” and “thermally processed food product” are used herein interchangeably. In some embodiments, thermally processed food product can be described or distinguished form the unprocessed food product based on CIE L*a*b* color values (see Examples section). In some embodiments, denaturation of the food product is induced or obtained by thermal processing. In some embodiments, thermal processing disrupts hydrogen bonds and non-polar interactions within the protein chain, destroying the secondary structures within the protein. In some embodiments, the denatured protein chains aggregate. In some embodiments, the food product is in a denatured state and characterized by at least one of: a hardness between 5 and 100 N, a cohesiveness between 0.1 and 0.8 N, a gumminess between 3 and 30 N, and adhesiveness between −5 and 5 Nmm, determined by Texture Profile Analyzer. In some embodiments, the denatured food product is characterized by a hardness between 5 N and 100 N, between 5 N and 50 N, between 5 N and 40 N, between 5 N and 30 N, between 10 N and 50 N, between 10 N and 30 N, including any range between, determined by Texture Profile Analyzer.

In some embodiments, the denatured food product is characterized by a gumminess between 3 N and 30 N, between 3 N and 20 N, between 3 N and 15 N, between 3 N and 10 N, between 5 N and 30 N, between 5 N and 20 N, between 10 N and 30 N, between 15 and 25 N, between 15 and 20 N including any range between, determined by Texture Profile Analyzer.

In some embodiments, the denatured food product is characterized by a cohesiveness between 0.1 N and 0.8 N, between 0.1 N and 0.6 N, between 0.1 N and 0.4 N, between 0.1 N and 0.2 N, between 0.2 N and 0.4 N, between 0.1 N and 0.5 N, between 0.2 N and 0.5 N, including any range between, determined by Texture Profile Analyzer.

In some embodiments, the denatured food product is characterized by a adhesiveness between −5 and 5 Nmm, between −5 and 0 Nmm, between 0 and 5 Nmm, between −5 and 0.5 Nmm, between −1 and 1 Nmm, including any range between, determined by Texture Profile Analyzer.

In some embodiments, the denatured food product is characterized by a water content of at least 10%, at least 20%, at least 30%, at least 40%, including any range in between.

In some embodiments, the denatured food product is characterized by a water content of between 5% and 65%, between 5% and 30%, between 5% and 55%, between 40% and 60%, between 20% and 60%, between 30% and 60%, including any range in between.

In some embodiments, the food product is characterized as being suitable for use as an equivalent product to meat, eggs, fat substitute, dairy products, sauces, dips, meat substitute products, plant-based products, or any combination thereof.

In some embodiments, the food product is characterized by at least 80%, at least 85%, at least 90% of the texture, color, and flavor of an equivalent product prepared using meat, eggs, dairy products, or any combination thereof.

In some embodiments, the food product is characterized by at least 60% of the consistency of an equivalent product prepared using eggs. In some embodiments, the food product is characterized by at least 60%, at least 65%, at least 70%, at least 75%, at least 80%, at least 85%, at least 90%, or at least 95% of the consistency of an equivalent product prepared using meat, eggs, dairy products, or any combination thereof, including any value therebetween. Each possibility represents a separate embodiment of the invention.

In some embodiments, the food product is devoid of meat, eggs, dairy products, or any combination thereof. In one embodiment, “free of” is “devoid of” or essentially “devoid of”.

As used herein, the terms “egg”, “meat”, “dairy products”, for example, as used when describing a “product devoid of meat, eggs, dairy products,” refers to an animal product or any component of an animal product.

In some embodiments, the food product is a vegetarian food product. In some embodiments, the food product is a vegan food product.

As used herein, the term “vegan” refers to properties of the components and indicates that the components are not sourced from or derived from an animal or animal product. As such, the components that are “vegan” are free of any animal products or animal byproducts. What constitutes an animal product or byproduct is well known in this field, and to those following a vegetarian or vegan diet. In particular, the term “animal product” refers to any animal parts, animal byproducts, or products produced by an animal. Some examples of materials that would be considered “animal products” include those parts of the animal that are consumable or typically prepared for consumption by humans (including, e.g., fat, flesh, blood, etc.). Products produced by an animal are also considered “animal products” as used herein and refer to the products produced by an animal without slaughtering the animal, (e.g., milk, eggs, honey, etc.). “Animal byproducts” are products that are typically not consumable by themselves but are the byproducts of slaughtering animals for consumption, e.g., bones, carcasses, etc. However, animal byproducts are often processed into human consumable foodstuffs, some well-known examples of which include gelatin, casein, whey, rennet, etc. As used herein, these processed animal byproducts (e.g., gelatin, casein, whey, rennet, etc.) are encompassed by the term “animal byproducts.” As described herein, “vegan” and “plant-based” components or ingredients are substantially free (or in some embodiments, completely free) of such animal products and byproducts.

In some embodiments, compositions and food products as described herein are suitable for a vegan diet and/or a vegetarian diet. For example, in embodiments in which the composition is suitable for a vegan diet, the composition may include primarily plant-based components such that the composition contains substantially no animal products, animal byproducts, or substantially no components derived from these animal sources.

In some embodiments, the food product is a ready to use product. In some embodiments, the food product is suitable for cooking via e.g., heating, frying, and baking.

In some embodiments, a food product or composition as described herein, comprises one or more flavoring agents. In some embodiments, a food product or composition as described herein comprises yeast, sugar, salt, and any combination thereof. Various natural or artificial flavoring agents are known to those skilled in the art, and can include, for example, salt, spices, sugar, sweeteners, monosodium glutamate, sulfuric flavoring agents such as black salt, or other flavoring agents.

In some embodiments, a food product or composition as described herein, comprises one or more coloring agents. Various natural or artificial coloring agents are known to those skilled in the art, and can include, for example, carotenoids such as beta-carotene, turmeric, annatto, mango yellow, or palm-based oils.

In some embodiments, a food product or composition as described herein, further comprises an emulsifier, a thickener, an oil, a nutrient, or any combination thereof.

In some embodiments, the oil is a vegetable-based oil. Examples of vegetable oils that may be used according to the present invention include, but are not limited to, soybean oil, safflower oil, linseed oil, corn oil, sunflower oil, olive oil, canola oil, sesame oil, cottonseed oil, palm oil, rapeseed oil, tung oil, or a blend of any of these oils. Alternatively, any partially hydrogenated vegetable oils or genetically modified vegetable oils can be used. Examples of partially hydrogenated vegetable oils or genetically modified vegetable oils include, but are not limited to, high oleic safflower oil, high oleic soybean oil, high oleic peanut oil, high oleic sunflower oil and high erucic rapeseed oil (crambe oil).

### The Method

According to some embodiments, the present invention provides a process for manufacturing a bigel. In some embodiments, the present invention provides a process for manufacturing a bigel an oleogel mixed with a hydrogel, wherein the hydrogel comprises water and a biopolymer and wherein a concentration of the biopolymer within the hydrogel is between 1% and 40% weight per weight (w/w); the oleogel comprises a vegetable oil and an oil structuring agent, and wherein a concentration of the oil structuring agent within the oleogel is between 0.5% and 30% (w/w); the biopolymer comprises a plant protein; and wherein the bigel is substantially devoid of phase separation and is characterized by a water content between 10% and 90% (w/w). In some embodiments, the bigel is characterized by a water content between 50% and 90% w/w. In some embodiments, the process comprises a. mixing a first solution comprising between 1% and 60% (w/w) of the biopolymer (i.e. the plant protein optionally further comprising a polysaccharide) with a second solution comprising an oil structuring agent, thereby obtaining a mixture; and b. homogenizing the mixture, thereby manufacturing the food product.

In some embodiments, the first solution comprises an aqueous solution. In some embodiments, the aqueous solution is devoid of more than 1%, more than 0.1%, more than 0.5%, more than 0.01% of an organic solvent.

In some embodiments, the first solution further comprises a cross-linking enzyme.

In some embodiments, the first solution is in a form of a hydrogel.

In some embodiments, the second solution comprises vegetable oil, as described hereinabove.

In some embodiments, a concentration of the oil structuring agent within the oil phase is between 0.1% (w/w) and 40% (w/w), between 0.5% (w/w) and 30% (w/w), between 0.7% (w/w) and 30% (w/w), between 0.9% (w/w) and 30% (w/w), between 1% (w/w) and 30% (w/w), between 5% (w/w) and 30% (w/w), between 10% (w/w) and 30% (w/w), between 15% (w/w) and 30% (w/w), between 20% (w/w) and 30% (w/w), between 0.1% (w/w) and 25% (w/w), between 0.5% (w/w) and 25% (w/w), between 0.7% (w/w) and 25% (w/w), between 0.9% (w/w) and 25% (w/w), between 1% (w/w) and 25% (w/w), between 5% (w/w) and 25% (w/w), between 10% (w/w) and 25% (w/w), or between 15% (w/w) and 25% (w/w), including any range therebetween. In some embodiments, a concentration of the oil structuring agent within the oil phase is between 5% (w/w) and 35% (w/w), between 5% (w/w) and 30% (w/w), between 10% (w/w) and 30% (w/w), between 5% (w/w) and 15% (w/w), between 5% (w/w) and 25% (w/w), between 15% (w/w) and 35% (w/w), between 15% (w/w) and 25% (w/w), between 15% (w/w) and 30%, including any range therebetween. Each possibility represents a separate embodiment of the present invention.

In some embodiments, the second solution is in a form of an oleogel.

In some embodiments, the mixing of the first solution and second solution is done at a ratio between 1:1 and 10:1, between 1:1 and 8:1, between 1:1 and 6:1, between 1:1 and 4:1, between 6:1 and 10:1, between 6:1 and 8:1, respectively including any range in between. Each possibility represents a separate embodiment of the present invention.

In some embodiments, the homogenizing comprises a speed between 5,000 rpm and 25,000 rpm, between 5,000 and 20,000 rpm, between 10,000 and 25,000 rpm, between 5,000 and 15,000 rpm, between 10,000 and 20,000 rpm, between 15, 000 and 25,000, including any range therebetween.

In some embodiments, the homogenizing is performed between 1 minute and 30 minutes, between 5 minutes and 30 minutes, between 10 minute and 30 minutes, or between 20 minute and 30 minutes, including any range therebetween. Each possibility represents a separate embodiment of the present invention.

In some embodiments, the homogenizing is performed at a temperature between 25° C. and 100° C., between 30° C. and 100° C., between 40° C. and 100° C., 25° C. and 80° C., between 30° C. and 80° C., or between 40° C. and 80° C., including any range therebetween. Each possibility represents a separate embodiment of the present invention.

In some embodiments, step a. and step b. are performed simultaneously. In some embodiments, step a. and step b. are performed subsequently.

In some embodiments, the first and/or second solution further comprises an additive. Non-limiting examples of additive is selected from: flavors, hydrocolloids, fibers, salts, aroma compounds, encapsulated ingredients (e.g., color and pigment), preservatives, taste additives (umami flavor, BBQ flavor) stabilizers, vitamins, thickener, emulsifier, or any combination thereof.

In some embodiments, the process further comprises a step preceding step b., of mixing a third solution comprising a plant protein with the first solution and second solution.

In some embodiments, the third solution further comprises a cross-linking enzyme. In some embodiments, the enzyme is transglutaminase.

In some embodiments, the homogenizing comprises cooling the mixture to a temperature between −20° C. and 30° C., between −10° C. and 30° C., between 0° C. and 30° C., between 5° C. and 30° C., or between 10° C. and 30° C., including any range therebetween. Each possibility represents a separate embodiment of the present invention.

In some embodiments, the food product is the food product described hereinabove.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Preparation Procedure

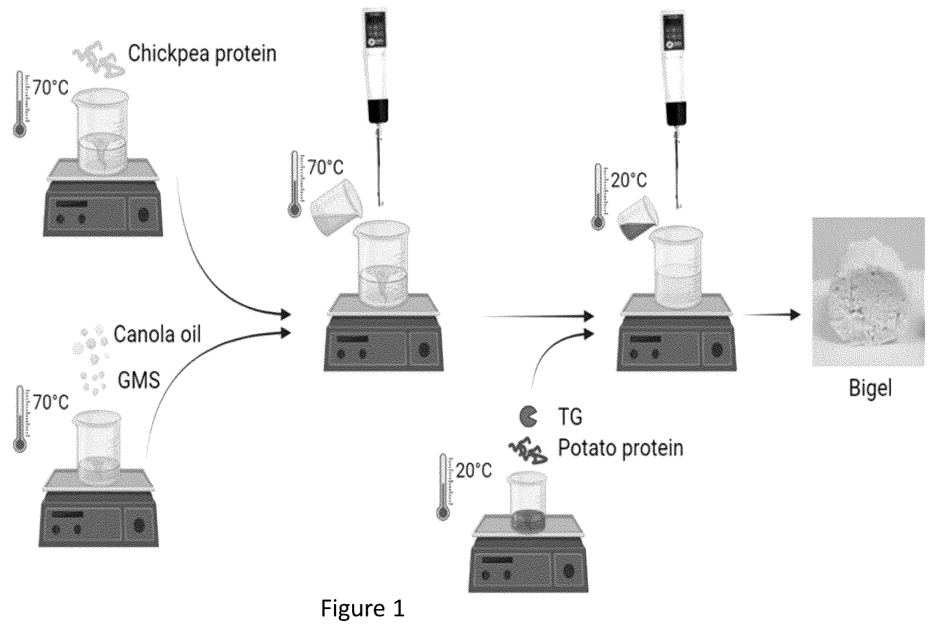

Bigels were prepared using hot emulsification procedure of the water and oil phases. Phases were prepared by dispersing the structuring agent, i.e., protein and oil structuring agent, in each phase and increasing the temperature in order to achieve a solution. Two stages preparation steps are introduced: first stage of mixing and homogenizing of the oil phase and first water phase with protein followed by second mixing and homogenizing stage with addition of protein and optionally an enzyme, finalized by cooling to room temperature (RT) (FIG. 1). The homogenization was achieved using ultra-high Turrax homogenizer device. Bigels can also be formulated using only the first homogenization step.

### Bigel Composition

Exemplary conditions used included protein concentration of 21% wt. in 50 mM Tris-HCl pH 10 buffer, glycerol monostearate (GMS) concentration of 20% wt., dissolution temperature of 60° C., and homogenization at 16000 rpm for 2.5 min. Wider concentrations of protein and oil gelator (oil structuring agent) can also be used.

### Bigel Characterization

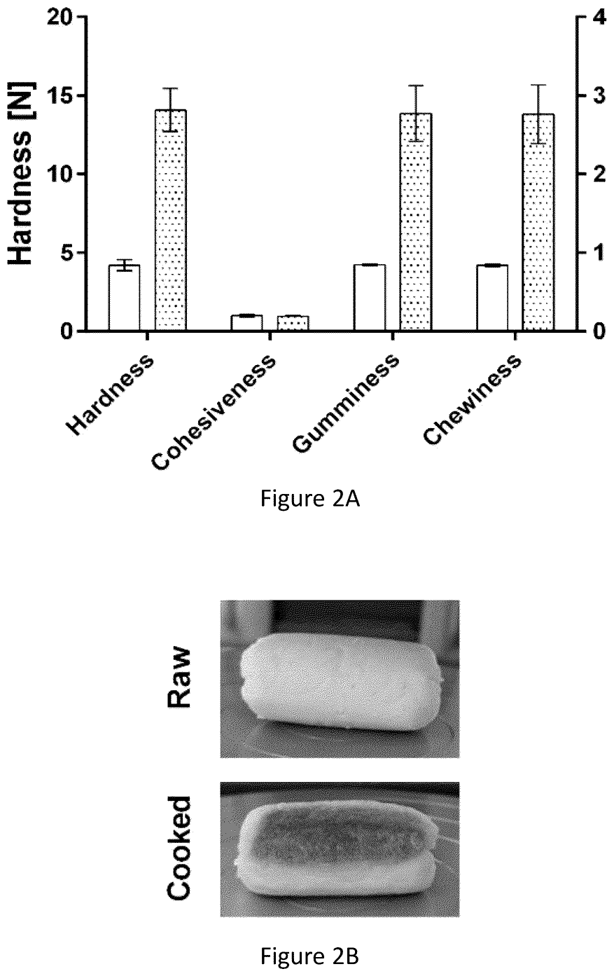

Bigel characterization was accomplished using common thermal and mechanical analysis. The mechanical properties analysis was done using texture profile analysis. Samples were prepared by pouring the hot mixture into a 22 mm dialysis tube and cutting 1 cm pucks after cooling and setting for 48 hr. Bigel pucks were compressed twice between two parallel plated to 50% of the initial height at constant speed of 50 mm/min using a 50 N load transducer. The following texture parameters were obtained: hardness at 50% of deformation, cohesiveness, and gumminess/chewiness. Hardness is defined by peak force (N) during the first compression cycle, cohesiveness was calculated as the ratio of the area under the second curve to the area under the first curve (dimensionless), while gumminess (parameter used for semisolid food) was obtained by multiplying hardness and cohesiveness, and chewiness (parameter used to describe solid food) was obtained by multiplying hardness, cohesiveness and springiness. Springiness is calculated as a ratio or percentage of a products recovery to its original height. All parameters were calculated using the NextGen Lloyd software. The results demonstrate the change in the hardness, chewiness and gumminess due to the cooking stage while the cohesiveness remain similar (FIG. 2A). It seems that the cooking process led to protein denaturation which produce harder protein network and harder bigel structure. Such results are expected in high protein products such as meat, which consist high content of protein. The effect of cooking on fat, in general, and fat substitute, in specific, was not studied up to date, although the melting behavior of these systems was examined and will be presented below. The visual appearance of the bigel before cooking demonstrate similar white appearance as animal-based fat while the image after cooking demonstrate the formation of brown crust resembling fried fat crust (FIG. 2B).

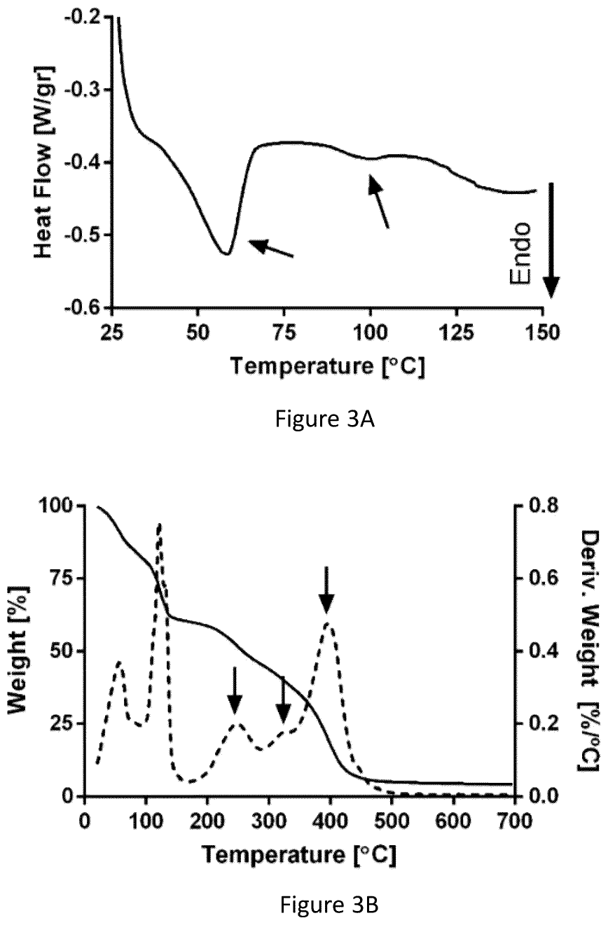

The bigel thermal properties were analyzed to obtain additional information related to the cooking process. The DSC thermogram revealed two characteristic endothermic thermal events during heating at around 60° C. and 100° C. (FIG. 3A), these events can be related to the GMS melting in the oil phase and protein denaturation in the water phase, respectively. These results strengthening our assumption related to the protein denaturation which led to bigel hardening. Interestingly, during the cooking process where the oleogel melted and liquefied inside the bigel matrix no significant oil leakage was observed. TGA analysis can demonstrate the decomposition footprint of various species in the sample.

In the current study the inventors could identify five distinct weight loss events at approximately 60° C., 124° C., 250° C., 320° C. and 400° C. which can be seen in the weight loss derivative curve (FIG. 3B). The inventors believe that the peaks at 60° C. and 124° C. can be related to the GMS melting and water dehydration, respectively. The weight loss period from 200° C. until 450° C. can be related to combination of oil and GMS decomposition with the protein decomposition. Oil decomposition spans over a wide range of temperatures due to the large variety of fatty acids, in general, three stages can be defined related to the decomposition of polyunsaturated, monounsaturated and saturated fatty acid where the decomposition of the unsaturated fatty acids occur at the beginning and can be related to the oil oxidative stability. Legume protein decomposition was found to occur over a wide temperature range between 200-500° C. with a maximum centered at around 320° C. The inventors suspect that the peak observed at ˜320° C. can be related to the protein decomposition in the bigel.

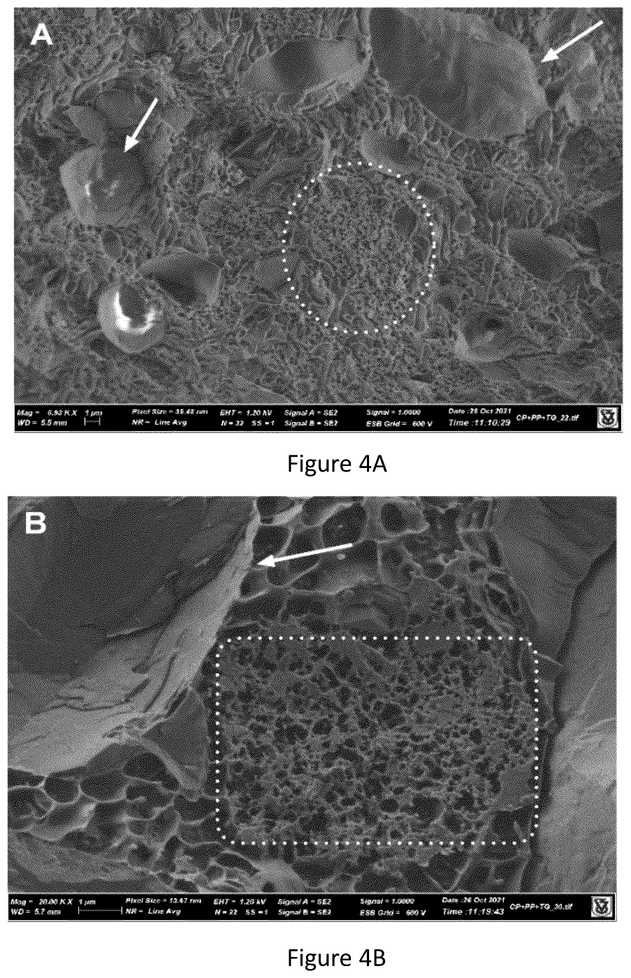

The bigel structure was analyzed using Cryo-SEM imaging where the oleogel droplets could be clearly seen (marked with an arrow) surrounded with protein network (marked with dotted line) (FIGS. 4A-4B). This result confirms our hypothesis suggesting that the bigel structure is based on combination of oleogel particles stabilized by protein network. The use of plant protein to stabilize fat droplet mimic the natural structure of meat systems. Therefore, the proposed bigel system can also act as a ‘meatless’ meat replacer with proper development of the current formulation.

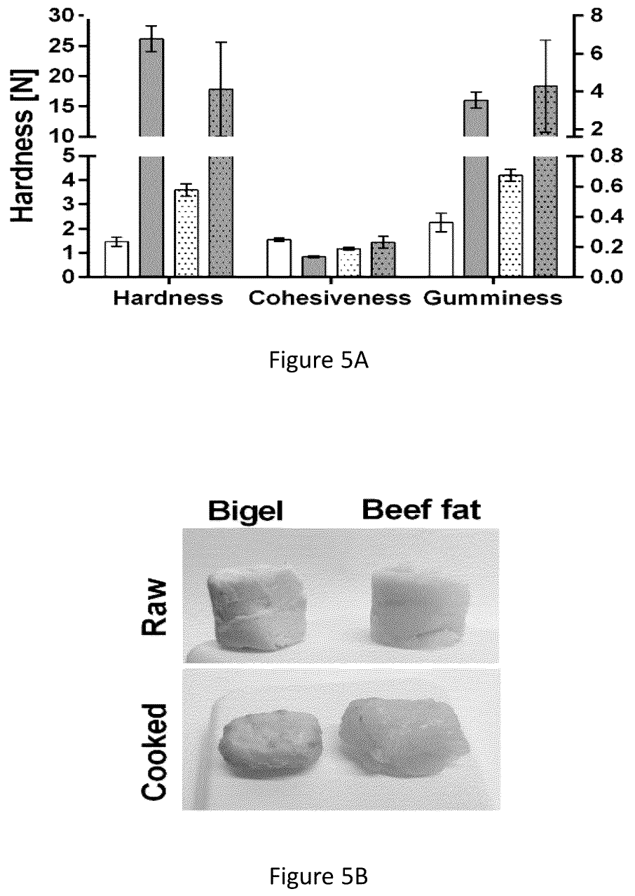

To further analyze the performance of bigel system in comparison with beef fat the inventors conducted a preliminary analysis of the two systems using texture analysis, (FIG. 5). In general, one can observe significantly higher hardness and gumminess values for the beef fat compared with the bigel formulation before and after cooking with comparable values of cohesiveness. Interestingly, the hardness and gumminess of the bigel significantly increased after cooking, probably due to the protein denaturation in the bigel matrix. The inventors believe that by understanding the role of each component, i.e., oleogel, protein, and interface, additional enzymatic cross-linking will allow better control of these properties and improve the bigel performance. Moreover, the images of the bigel compared with the beef fat imply on the similar appearance of the fat in the future applications such as the marble color in beef products (FIG. 5B).

### Example 2

### Bigel Formed from a Chickpea Protein

### Preparation of Various Bigel Formulations

Bigels were prepared by mixing two phases; water and oil, consisting different concentrations of structuring agents; chickpea protein (CP), which were isolated from fresh chickpea seeds, in the water phase and glycerol monostearate (GMS) in the oil phase, based on Table 1. For example, bigel with 50:50 water:oil ratio and 10% wt. protein and 20% wt. GMS was prepared by mixing 5 g dispersion of 100 mg/ml protein and 5 g oleogel with 4 g oil and 1 g GMS.

The preparation procedure included heating the chickpea protein dispersion to ˜75° C. and the GMS/oil mixture to 70° C. (above the melting temperature of the GMS) under constant stirring, followed by mixing of the two phases and homogenization (Omni International, Inc, Kennesaw, Georgia, USA). The CP dispersions were prepared using distilled water after stirring overnight at 4° C. The best formulation which exhibited consistency, stability and strength was chosen for further examination and improvement.

TABLE 1
Composition of the different phases
used to formulate various bigels.

| Component | Water phase | Oil phase |
|---|---|---|
| Chickpea protein | 5, 10, 15 [% wt] | — |
| | of the water phase | |
| GMS | — | 10, 20, 30 [% wt] |
| | | of the oil phase |

| | |
|---|---|
| Hydrogel:Oleogel ratio | 90:10, 80:20, 70:30, 50:50 |

The initial assessment of the formulation performance was evaluated visually. For that, samples with different water:oil ratios (90:10, 80:20, 70:30, 50:50), GMS concentration (10-30% wt. of the oil content), and protein concentration (5-15% wt. of the water phase) were examined.

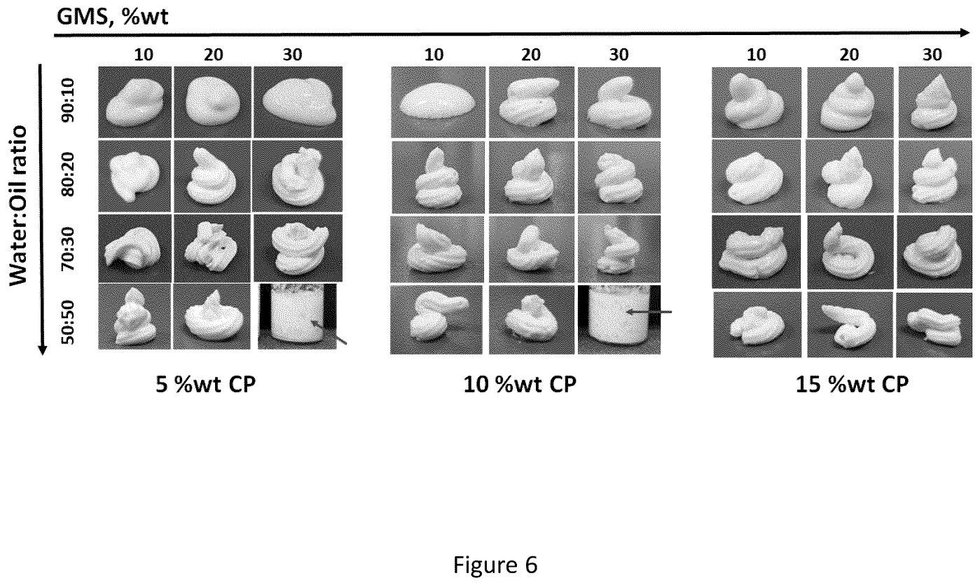

The successful formation of stable gel network was verified by vial inversion test while in order to better observe self-supporting ability, bigels were shaped using a pastry bag with a small star tip (FIG. 6). Overall, most bigels were homogenous with no signs of phase separation during homogenization and after overnight storage at 4° C., implying on their immediate stability. The texture was ranging from soft as “coffee creamer” to self-supporting and hard as “Philadelphia cream cheese”, based on the formulation used. These mechanical differences were found to be correlated to the overall phase composition. Moreover, milky white to beige/yellowish color was observed as protein percentage increased in the bigel formulation.

A direct correlation between the bigels firmness and oleogel ratio was found, while at a lower oleogel fraction, the bigel had a less sticky and easy spreading texture. Beside the oleogel ratio, the protein amount also contributed to firmer texture (FIG. 6). For example, at the lowest protein concentration (5% wt.) and water:oil ratio (90:10), regardless of GMS concentration, the samples were soft and weak lacking of self-supporting texture. The appearance of self-standing texture in the presence of the lowest protein concentration (5% wt.) was observed with an increase in oil concentration above 20% wt. oil (excluding the sample with 20% wt. GMS and 20% wt oil) (FIG. 6). When protein concentration increased up to 10% wt., still, at the lowest oleogel ratio, the bigel structure was very soft without self-standing ability, indicating on the importance of the oleogel fraction in providing firmer texture. On the other hand, highest protein concentration (15% wt.) led to stable, smooth and thick bigel texture, even with the lowest oleogel fraction. The bigels with 15% wt. protein and 10% wt. and 20% wt. oil fractions resembled mayonnaise texture on touch, and due to the beige/yellowish color resembled mayonnaise appearance overall. The bigels produced with the highest oleogel fractions (50% wt. oil and 30% wt. GMS) had homogenous texture only in the presence of the highest protein concentration (15% wt.), while abrupt phase separation upon homogenisation was observed when 5% wt. or 10% wt. CP was used (FIG. 6). This suggests that protein concentration of 5% wt. or 10% wt. was insufficient and enabled to stabilize oil with high GMS concentration (30% wt.), thus resulting in oil leakage. Overall, bigels produced with the highest oil fraction (50% wt.) were stiff, with grainy texture that are hard to spread or to shape.

The structural integrity of most bigels remained stable with no signs of oil/water separation, or flow under gravity after more than two months of storage at 4° C. Such results suggest good long-term stability of the system due to good compatibility between the hydrogel and oleogel phases. However, upon storage, the bigels with the lowest water:oil ratio showed some degree of water syneresis. The bigels stability can be attributed to the CP, that possesses good emulsifying and the high concentration (>10% wt.) and can form a gel upon heat treatment. On the other hand, GMS is expected to take a role in the bigel stabilization through stabilization of the water-oil interface due to its surface-active property and solidification of the oil phase via crystallization and network formation.

The ability to improve the bigels properties was examined by adding potato protein, or a combination of potato protein and TG enzyme. The addition of potato protein can potentially increase the overall protein content and amino acid variety, while TG can increase the protein network stability, both leading to perfection of the texture of the bigels. The improved bigel formulation was characterized in raw and fried state to demonstrate the potential food applicability of the system.

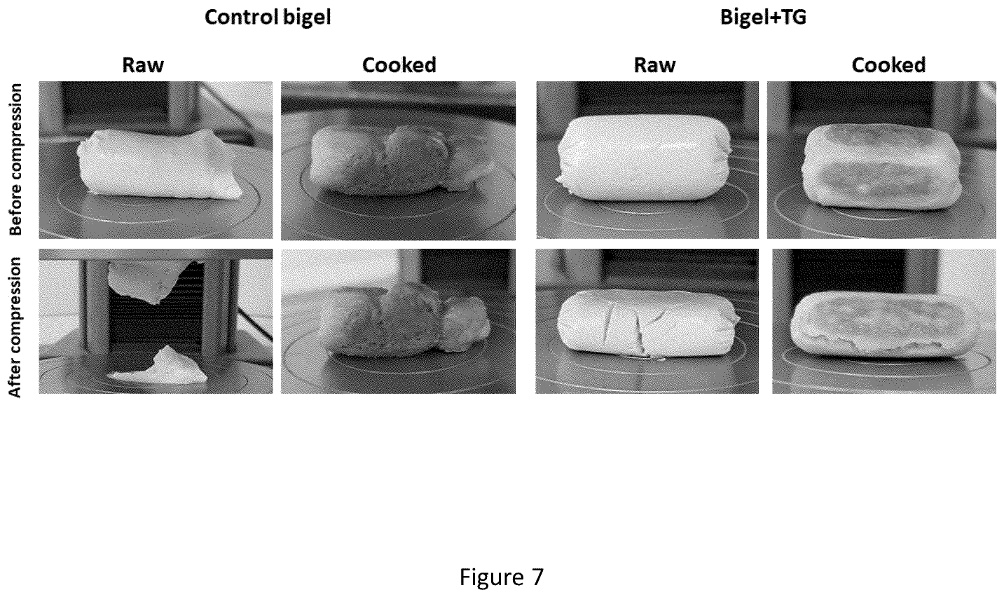

Addition of potato protein and TG to the original bigel system with only CP protein significantly changed the material behaviour with respect to appearance, mechanical properties, thermal behaviour and colour. The appearance of non-crosslinked and crosslinked bigels, both raw and cooked. The bigels were allowed to set in a cellulose based “casing” while before further characterization the casing was peeled off. The crosslinked bigel exhibited firm, easy to peel, and stable texture which maintained the same shape during handling. Contrary, the non-crosslinked bigel was significantly softer and difficult to peel due to higher stickiness, thus was harder to handle as observed in FIG. 7.

The crosslinked bigel did not change shape after cooking, while the raw non-crosslinked bigel with soft appearance turned harder after cooking. On the cross section, TG-crosslinked bigel resembled an appearance similar to chicken breast or semi-solid cheese.

The moisture content was higher in the control bigel with CP and potato proteins without TG cross-linking (56.5%) compared to TG-crosslinked bigel (49.8%) indicating on more rigid and dense network while using TG compared to more sticky and soft control bigel.

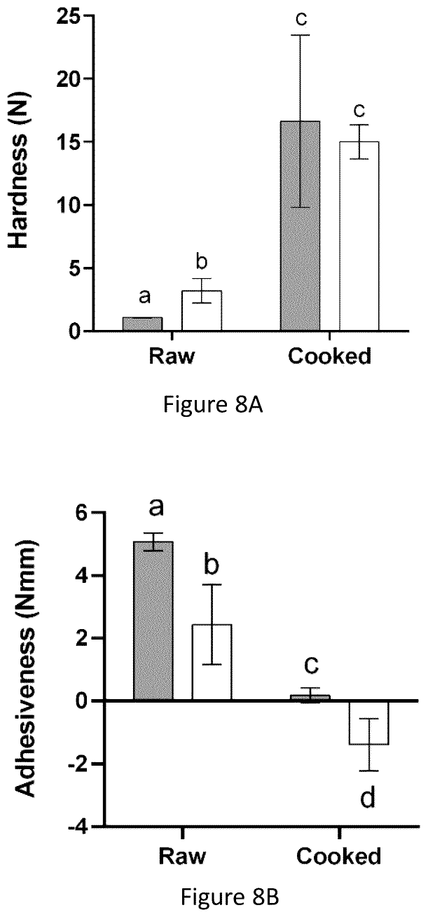

The raw TG-crosslinked bigels had three fold higher hardness values compared to control bigels, however upon cooking, hardness values were similar in both bigels (FIG. 8A). A decrease in stickiness also apparent in the high adhesiveness value of the raw bigels without TG, compared with the TG crosslinked raw bigel (FIG. 8B).

The thermal decomposition of the bigels was analyzed by TGA, higher water content was observed in the control bigel compared to the TG-crosslinked bigel, which can be correlated to the moisture content results.

### Bigels Color Analysis

CIE L*a*b* color values of the control and TG-crosslinked bigels, before and after cooking, exhibited different effects with respect to TG addition and cooking. Addition of TG to bigel formulation did not significantly changes the L* and a* values, which ranged between 79.84-81.39 and 3.73-4.31, respectively. Moreover, similar values were observed for the whiteness index of the raw bigels that ranged between 78.58 and 80.16 without significant differences, indicating a whitish appearance for both samples, without and with TG, which opens possibilities for various food applications. The obtained WI results are slightly lower compared to SPI-based fat mimetic composed of wheat fibers and palm fat, with WI between 84-87, probably due to protein type and its lower content. A small increase in b* values from 6.31 to 8.42 could be seen with addition of TG, meaning that color shifted towards yellow on the b* axis, which can be attributed to a lower water amount and it is in correlation with the measured moisture. However, these slight differences in b* value were hardly visible, and are referred to as negligible.

The effect of cooking can be visually observed and quantitively determined in the CIE L*a*b* color values. A clear reduction in the L* and increase in a* and b* values were observed due to the cooking process. Reduction in lightness (L*) is expected, as well as increase in yellowness and redness due to browning of bigels upon cooking. In addition, the browning index of cooked bigels significantly increased with values ranging between 69.84-75.35 as opposed to the values before cooking ranging between 11.44-12.10. Browning process is caused by different reactions, mostly as a result of Maillard reaction which takes place between the carbonyl groups at the reducing ends of sugars and the amino acid groups of proteins. The presence of proteins and other components in the system can facilitate such a reaction leading to the observed change in browning.

In addition to chickpea protein, canola protein and the bigel they formed were analyzed, as disclosed above. The inventors observed that TG-induced crosslinking significantly improves the bigel structure.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A bigel, comprising an oleogel mixed with a hydrogel, wherein:
said hydrogel comprises water and a biopolymer and wherein a concentration of the biopolymer within said hydrogel is between 1% and 40% weight per weight (w/w);
said oleogel comprises a vegetable oil and an oil structuring agent, and wherein a concentration of the oil structuring agent within said oleogel is between 0.5% and 30% (w/w);
said biopolymer comprises a plant protein, a polysaccharide, including any salt or any combination thereof; and wherein said bigel is characterized by a water content between 10% and 90% (w/w).

2. The bigel of claim 1, wherein a concentration of said oleogel within said bigel is between 10% and 80% (w/w).

3. The bigel of claim 1, wherein said oleogel is characterized by a viscosity between 10 cP and 500000000 cP at a temperature between 2° and 25° C.

4. The bigel of claim 1, wherein said bigel is substantially devoid of phase separation at a temperature below 100° C.

5. The bigel of claim 1, wherein said plant protein is at least partially cross-linked, optionally wherein said crosslinked is via a covalent bond or via a physical bond, further optionally wherein said plant protein is at least partially cross-linked via a covalent bond formed via a biological cross-linking by an enzyme, or via a chemical crosslinking by a cross-linking agent.

6. The bigel of claim 1, wherein said plant protein is in the form of self-assembled matrix, and wherein said oleogel is in a form of particles embedded within the matrix.

7. The bigel of claim 6, wherein said particles are characterized by a particle size between 1 μm and 200 μm.

8. The bigel of claim 1, wherein said bigel comprises between 5% (w/w) and 80% (w/w) of said plant protein.

9. The bigel of claim 1, wherein said bigel comprises between 10% (w/w) and 80% (w/w) of said vegetable oil.

10. The bigel of claim 1, wherein any one of: (i) said plant protein is selected from chickpea protein, potato protein, garbanzo protein, fava beans protein, yellow pea protein, rice protein, rye, golden lentil, chana dal, soybean, sorghum, sprouted green lentil, du pung style lentil, white lima bean, hemp, corn, rapeseed, canola including any fraction or any combination thereof; (ii) said oil structuring agent is selected from the group comprising a wax, glycerol monostearate, stearic acid, sorbitan monostearate, phytosterol, or any combination thereof; (iii) said vegetable oil is selected from the group comprising soybean oil, olive oil, rice oil, hemp seed oil, safflower oil, canola oil, sunflower oil, or any combination thereof; (iv) said polysaccharide is selected from the group comprising alginate, chitosan, hyaluronic acid, pectin, a starch, a modified starch, a gum, agarose, gellan, locust bean gum, Guar gum, xanthan gum, carrageenan, including any salt, or any combination thereof.

11. (canceled)

12. (canceled)

13. (canceled)

14. (canceled)

15. (canceled)

16. A food product comprising the bigel of claim 1, optionally wherein said food product is shapeable, spreadable or both.

17. (canceled)

18. The food product of claim 16, characterized by a hardness between 1 N and 10000 N.

19. The food product of claim 16, being selected from an equivalent product to meat, egg substitute, fat substitute, dairy product substitute, meat substitute, and a plant-based food product, or any combination thereof.

20. A process for manufacturing a bigel comprising an oleogel mixed with a hydrogel, wherein said hydrogel comprises water and a biopolymer and wherein a concentration of the biopolymer within said hydrogel is between 1% and 40% weight per weight (w/w); said oleogel comprises a vegetable oil and an oil structuring agent, and wherein a concentration of the oil structuring agent within said oleogel is between 0.5% and 30% (w/w); said biopolymer comprises a plant protein; and wherein said bigel is substantially devoid of phase separation and is characterized by a water content between 10% and 90% (w/w), the process comprising:
a. mixing a first solution comprising between 1% and 60% (w/w) of a plant protein with a second solution comprising an oil structuring agent, thereby obtaining a mixture;
b. homogenizing said mixture, thereby manufacturing said bigel.

21. The process of claim 20, wherein said first solution comprises any one of (i) an aqueous solution; (ii) a vegetable oil; and (iii) both (i) and (ii).

22. (canceled)

23. The process of claim 20, wherein a concentration of said oil structuring agent within said second solution is between 0.5% (w/w) and 30% (w/w).

24. (canceled)

25. The process of claim 20, further comprising a step of adding a surfactant to said mixture, optionally wherein the surfactant is selected from lecithin, glycerol, polysorbate, sorbitan ester, sodium stearoyl lactylate, including any slat or any combination thereof.

26. The process of claim 20, wherein said homogenizing is at least one step comprising: (i) homogenizing comprising a speed between 5000 rpm and 25000 rpm; (iii) homogenizing performed between 1 minute and 30 minutes, and (iv) homogenizing performed at a temperature between 25° C. and 100° C.

27. (canceled)

28. The process of claim 20, further comprising a step preceding step b., of mixing a third solution optionally comprising (i) a plant protein with the first solution and second solution and (ii) a cross-linking enzyme optionally being transglutaminase.

29. (canceled)

30. (canceled)

31. The process of claim 20, wherein said homogenizing comprises cooling said mixture to a temperature between −20° C. and 30° C.

32. (canceled)
